(19) United States
(12) Patent Application Publication
(10) Pub. No.: US 2016/0323496 A1
(43) Pub. Date: Nov. 3, 2016

(54) HAND-HELD PHOTOGRAPHIC EQUIPMENT FOR TAKING SELFIES

(71) Applicant: HON HAI PRECISION INDUSTRY CO., LTD., New Taipei (TW)

(72) Inventors: TUNG-TSO TSAI, New Taipei (TW); CHIH-YUAN CHUANG, New Taipei (TW); JUNG-YI LIN, New Taipei (TW); CHIH-TE LU, New Taipei (TW); TSUNG-YUAN TU, New Taipei (TW); PO-JEN HSU, New Taipei (TW); SHU-YUAN CHANG, New Taipei (TW)

(21) Appl. No.: 14/735,860

(22) Filed: Jun. 10, 2015

(30) Foreign Application Priority Data
Apr. 30, 2015 (TW) 104114008

(51) Int. Cl. H04N 5/232; H04N 5/225

(52) U.S. Cl. CPC H04N 5/23203; H04N 5/23293; H04N 5/2251

(57) ABSTRACT

Photographic equipment, which is capable of electrically connecting to an electronic device, including: a rod body; a fixing device used to fix the electronic device, which is attached to a first end of the rod body; a communication interface used to electrically connect to the electronic device to enable communication between the photographic equipment and the electronic device; a screen located on the rod body, and used for previewing an image taken by a camera of the electronic device; and a control unit attached to a second end of the rod body, which is operable to control the electronic device and the photographic equipment.

### CROSS-REFERENCE TO RELATED APPLICATIONS

This application claims priority to Taiwanese Patent Application No. 104114008 filed on Apr. 30, 2015, the contents of which are incorporated by reference herein.

### FIELD

The subject matter herein generally relates to photographic equipment, and particularly to photographic equipment for taking selfies.

### BACKGROUND

Users like to take selfie photos with an electronic device. However, it's inconvenient to take photos by themselves.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device.

FIG. 2 is a block diagram of one embodiment of a photographic equipment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

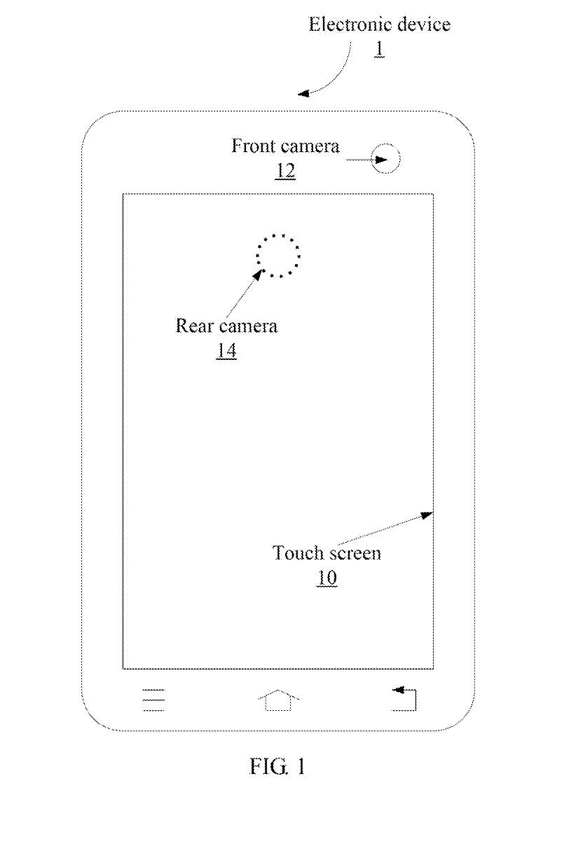

FIG. 1 illustrates a block diagram of one embodiment of an electronic device. In at least one embodiment as shown in FIG. 1, an electronic device 1 includes, but is not limited to, a touch screen 10, a front camera 12 and a rear camera 14. In one embodiment, the electronic device 1 can be a tablet computer, a mobile phone, or any other electronic device with a camera. Usually, pixels of the rear camera 14 are higher than pixels of the front camera 12. FIG. 1 illustrates only one example of the electronic device 1 that can include more or fewer components than illustrated, or have a different configuration of the various components in other embodiments.

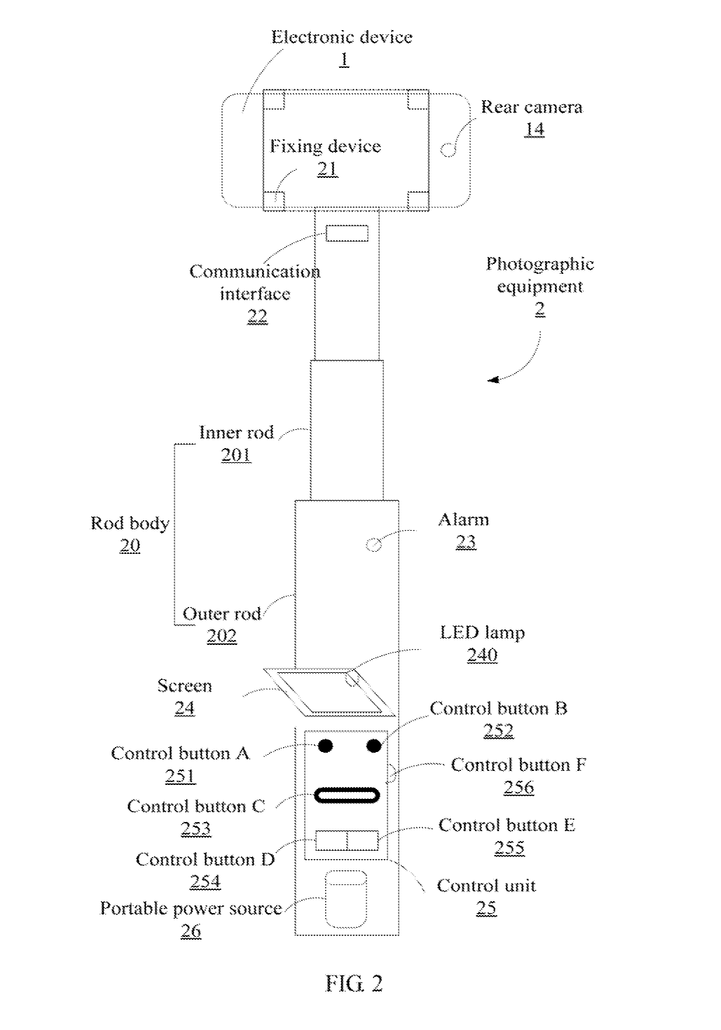

FIG. 2 illustrates a block diagram of one embodiment of photographic equipment. In at least one embodiment as shown in FIG. 2, the photographic equipment 2 includes, but is not limited to, components such as a rod body 20, a fixing device 21, a communication interface 22, an alarm 23, a screen 24, a control unit 25, a portable power source 26 and circuits that electrically connect to the above mentioned components (the circuits are inside the rod body 20 of the photographic equipment 2 and not displayed on the FIG. 2).

In at least one embodiment, the rod body 20 comprises an inner rod 201 and an outer rod 202. The outer rod 202 and the inner rod 201 are connected with each other, and can move telescopically to each other to make the photographic equipment 2 long or short. In some embodiments, the outer rod 202 of the photographic equipment 2 can be held by a user.

In at least one embodiment, the fixing device 21 can be attached to an end of the inner rod 201 of the photographic equipment 2, and used for removable fixing the electronic device 1, the rear camera 14 can be fixed to face the user to take photos of the user. In some embodiments, the fixing device 21 can fix the electronic device 1 by way of clamping or chucking. In some embodiments, the front camera 12 can be fixed to face the user to take photos of the user. As in FIG. 2, the rear camera 14 of the electronic device 1 is fixed to face the user.

In at least one embodiment, the communication interface 22 can be placed on the inner rod 201, and is capable of electrically connecting to the electronic device 1, to be used to enable communication between the photographic equipment 2 and the electronic device 1. In some embodiments, the communication interface 22 can be a wired communication interface, for example, an Universal Serial Bus (USB) interface, or a High Definition Multimedia Interface (HDMI). Alternatively, the communication interface 22 can be a wireless communication interface, for example, a Wi-Fi interface, or a BLUETOOTH interface.

In at least one embodiment, the alarm 23 can be placed on the inner rod 201 or the outer rod 202. In some embodiments, the alarm 23 can send out an alarm sound to remind the user when the electronic device 1 is not within a signal range of the wireless connection (preferably, BLUETOOTH connection) of the photographic equipment 2.

In at least one embodiment, the screen 24 can be located on the outer rod 202. In some embodiments, the screen 24 can pitch or roll around a vertical line of the rod body 20 with a pitch angle or a roll angle. In one embodiment, the pitch angle is [0°-180°], and the roll angle is [0°-360° ].

In some embodiments, the screen 24 can preview an image of the user taken by the rear camera 14 or the front camera 12 of the electronic device 1. In some embodiments, there can be at least one light emitting diode (LED) lamp 240 around the screen 24. The at least one LED lamp 240 can be used for lighting and/or exposure compensation.

In at least one embodiment, the portable power source 26 can provide power for the electronic device 1. In some embodiments, the portable power source 26 can be placed anywhere on the rod body 20.

In at least one embodiment, the control unit 25 can be attached to an end of the outer rod 202, and close to a place where operation can be preformed by the user holding the outer rod 202. The control unit 25 operable to control the electronic device 1 and the photographic equipment 2 and can comprise a control button A 251, a control button B 252, a control button C 253, a control button D 254, a control button E 255, and a control button F 256. The control buttons can be press type buttons, toggle buttons, stroke buttons, or lever buttons.

In at least one embodiment, the control button A 251 can control the screen 24 to turn on/turn off. When the control button A 251 is pressed, the screen 24 is turned on and an image of the user taken by the camera of the electronic device 1 is displayed.

In at least one embodiment, the control button B 252 can control the portable power source 26 to provide power for the electronic device 1.

In at least one embodiment, the control button C 253 can control the electronic device 1 to trigger the camera to take photos. In some embodiments, the camera of the electronic device 1 can generate a “take image” signal, when taking an image of the user. The communication interface 22 can receive and send the taken image signal to the screen 24. The user can preview whether the image is good by viewing the screen 24. When the image is considered to be good, the user can press the control button C 253. When the control button C 253 is pressed, the control unit 25 can generate a control signal and send the control signal to the electronic device 1. The electronic device 1 can trigger the camera to capture an image after receiving the control signal sent by the control unit 25.

In some embodiments, the control button D 254 and the control button E 255 can control camera focal length of the electronic device 1 to zoom in and zoom out.

In at least one embodiment, the control button F 256 can control the at least one LED lamp 240 to open/close. In some embodiments, the control button F 256 can control to increase/decrease brightness of the at least one LED lamp.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

1. A photographic equipment for taking selfies, which is capable of electrically connecting to an electronic device, the photographic equipment comprising:
a rod body;
a fixing device attached to a first end of the rod body, the fixing device configured to removable fix the electronic device;
a communication interface configured to electrically connect to the electronic device to enable communication between the photographic equipment and the electronic device;
a screen located on the rod body, used for previewing an image taken by a camera of the electronic device; and
a control unit attached to a second end of the rod body, the control unit operable to control the electronic device and the photographic equipment;
wherein the control unit comprises a third control button, when the communication interface receives a “take image” signal from the camera of the electronic device, the communication interface sends the “take image” signal to the screen, the screen previews the image taken by the camera; when the third control button is pressed to indicate that the image is considered to be good, the control unit generates and sends a control signal to the electronic device to trigger the camera to capture the image.

2. The photographic equipment according to claim 1, wherein the rod body comprising an outer rod and an inner rod, the outer rod and the inner rod are connected with each other, and can move telescopically to each other to make the photographic equipment long or short.

3. The photographic equipment according to claim 2, wherein the communication interface placed on the inner rod of the rod body, the communication interface is a wired communication interface and/or a wireless communication interface communication.

4. The photographic equipment according to claim 1, wherein the screen pitch or roll around a vertical line of the rod body with a pitch angle or a roll angle, and the pitch angle is [0°-180°], and the roll angle is [0°-360°].

5. The photographic equipment according to claim 1, wherein the screen's around has at least one LED lamp, used for lighting/exposure compensation.

6. The photographic equipment according to claim 5, wherein the control unit comprising:
a six control button used to control the at least one LED lamp to open/close, and control to increase/decrease brightness of the at least one LED lamp.

7. The photographic equipment according to claim 6, wherein the control unit further comprising:
a second control button used to control a portable power source to provide power for the electronic device;
a fourth control button used to control camera focal length of the electronic device to zoom in; and
a fifth control button used to control camera focal length of the electronic device to zoom out.

8. The photographic equipment according to claim 7, wherein the portable power source electrically connect to the rod body.

9. The photographic equipment according to claim 1, wherein the control unit comprising:
a first control button used to control the screen to turn on/turn off.

10. The photographic equipment according to claim 1, further comprises:
an alarm electrically placed on the rod body, sending out an alarm sound to remind the user when the electronic device is not within a signal range of the wireless connection of the photographic equipment.
